(19) United States
(12) Patent Application Publication
(10) Pub. No.: US 2018/0229327 A1
(43) Pub. Date: Aug. 16, 2018

(54) METHOD FOR CREATING CLAD STRUCTURES USING RESISTANCE SEAM WELDING

(71) Applicant: EDISON WELDING INSTITUTE, INC., Columbus, OH (US)

(72) Inventors: Jerry E. GOULD, Columbus, OH (US); Wendell JOHNSON, Troy, OH (US); Dave WORKMAN, Columbus, OH (US); James CRUZ, Columbus, OH (US)

(21) Appl. No.: 15/951,738

(22) Filed: Apr. 12, 2018

Related U.S. Application Data
(63) Continuation of application No. 13/909,835, filed on Jun. 4, 2013, now abandoned.
Application No. 13/909,835 is a continuation-in-part of application No. 12/412,685, filed on Mar. 27, 2009, now abandoned.
(60) Provisional application No. 61/788,405, filed on Mar. 15, 2013.
(60) Provisional application No. 61/664,423, filed on Jun. 26, 2012.

(51) Int. Cl. B23K 11/00; B23K 11/06

(52) U.S. Cl. CPC B23K 11/00; Y10T 428/12931; B23K 11/066; B23K 11/0013; B23K 11/0006

(57) ABSTRACT

A method for creating a clad structure, comprising providing a substrate having an inner surface and an outer surface; providing a cladding material, wherein the cladding material is placed on the inner surface of the substrate, the outer surface of the substrate, or both; providing a surface activation material that is disposed between the substrate and the cladding material; providing at least one resistance welding device, wherein the at least one resistance welding device includes at least one electrode wheel that directly contacts the cladding material, and wherein the at least one resistance welding device generates resistance heating and pressure sufficient to melt the surface activation material and form a localized bond between the substrate and the cladding layer; and traversing the at least one electrode wheel across the cladding material and substrate to propagate the localized bond between the cladding material and the substrate and create a clad structure.

### CROSS-REFERENCE TO RELATED APPLICATIONS

This application is a continuation of U.S. patent application Ser. No. 13/909,835 filed on Jun. 4, 2013 and entitled “System for Creating Clad Materials Using Resistance Seam Welding”, which was a continuation-in-part of U.S. patent application Ser. No. 12/412,685 filed on Mar. 27, 2009 and entitled “Method of Creating a Clad Structure Utilizing a Moving Resistance Energy Source”. U.S. patent application Ser. No. 13/909,835 also claimed the benefit of U.S. Provisional Patent Application Ser. No. 61/788,405 filed on Mar. 15, 2013 and entitled “Resistance Seam Welding for Use in Cladding of Pipe”; and U.S. Provisional Patent Application Ser. No. 61/664,423 filed on Jun. 26, 2012 and entitled “Resistance Seam Welding for Use in Cladding of Pipe”; the disclosures of which are incorporated by reference herein in their entirety and made part of the present utility patent application for all purposes.

### BACKGROUND OF THE INVENTION

There are numerous situations in industry (e.g., oil and gas) where corrosive or erosive media may be a concern, such as, for example, acidic, caustic, abrasive, and oxidizing environments. Clad materials offer opportunities to maximize the characteristics of individual materials for utility in such environments. Current fabrication approaches for creating clad materials in heavy industries include technologies ranging from arc deposition to explosion bonding. These technologies offer various mechanisms for material deposition, but all include high implicit costs.

Clad pipe typically uses a steel outer case and a nickel base liner, which are on the order of 3 mm thick. Current fabrication methods or processes include roll bonding and mechanical cladding. The former is a complex method of diffusion bonding the cladding material to steel plates at a mill, rolling the product to service thicknesses, then fabricating pipe using the UOE (U-forming, O-forming and final expansion) process. This method creates a high metallurgical integrity bond but is very expensive. Mechanical cladding includes forming the cladding material into a tube, inserting this tube into the candidate pipe, and mechanically expanding the liner. This is a more cost-effective method of lining pipe, but no metallurgical bond is formed between the liner and the substrate. Thus, there is an ongoing need for a more effective, less expensive method for creating clad pipe for use in oil and gas applications.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a first method for creating a clad structure is provided. This method includes providing a substrate, wherein the substrate further includes an inner surface and an outer surface; providing a cladding material, wherein the cladding material is placed on the inner surface of the substrate, the outer surface of the substrate, or both the inner and outer surfaces of the substrate; providing a surface activation material, wherein the surface activation material is disposed between the substrate and the cladding material; providing at least one resistance welding device, wherein the at least one resistance welding device includes at least one electrode wheel that directly contacts the cladding material, and wherein the at least one resistance welding device generates resistance heating and pressure sufficient to melt the surface activation material and form a localized bond between the substrate and the cladding layer; and traversing the at least one electrode wheel across the cladding material and substrate to propagate the localized bond between the cladding material and the substrate and create a clad structure.

In accordance with another aspect of the present invention, a second method for creating a clad structure is provided. This method includes providing a curved substrate, wherein the curved substrate further includes an inner surface and an outer surface; providing a cladding material, wherein the cladding material is placed on the inner surface of the curved substrate, the outer surface of the curved substrate, or both the inner and outer surfaces of the curved substrate; providing a surface activation material, wherein the surface activation material is disposed between the curved substrate and the cladding material; providing at least one resistance welding device, wherein the at least one resistance welding device includes at least one electrode wheel that directly contacts the cladding material, and wherein the at least one resistance welding device generates resistance heating and pressure sufficient to melt the surface activation material and form a localized bond between the curved substrate and the cladding layer; traversing the at least one electrode wheel across the cladding material and curved substrate to propagate the localized bond between the cladding material and the curved substrate and create a clad structure; and cooling the electrode wheel, cladding layer and curved substrate after the bond between the cladding layer and curved substrate has been formed.

In yet another aspect of this invention, a third method for creating a clad structure is provided. This method includes providing a cylindrical substrate, wherein the cylindrical substrate further includes an inner surface and an outer surface; providing a cladding material, wherein the cladding material is placed on the inner surface of the cylindrical substrate, the outer surface of the cylindrical substrate, or both the inner and outer surfaces of the cylindrical substrate; providing a surface activation material, wherein the surface activation material is disposed between the cylindrical substrate and the cladding material; providing at least one resistance welding device, wherein the at least one resistance welding device includes at least one electrode wheel that directly contacts the cladding material, and wherein the at least one resistance welding device generates resistance heating and pressure sufficient to melt the surface activation material and form a localized bond between the cylindrical substrate and the cladding layer; traversing the at least one electrode wheel across the cladding material and cylindrical substrate to propagate the localized bond between the cladding material and the cylindrical substrate and create a clad structure; and cooling the electrode wheel, cladding layer and cylindrical substrate with water after the bond between the cladding layer and cylindrical substrate has been formed.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a first perspective view of a clad structure in accordance with an exemplary embodiment of the present invention;

FIG. 2 is a second perspective view of a clad structure in accordance with an exemplary embodiment of the present invention showing the placement of a welding wheel on the interior of the structure;

FIG. 3 is a third perspective view of a clad structure in accordance with an exemplary embodiment of the present invention showing the placement of a welding wheel on the interior of the structure, a welding wheel on the exterior of the structure, and a base plate and rollers on one end of the structure; and

FIG. 4 is an end view of a clad structure in accordance with an exemplary embodiment of the present invention showing the placement of a welding wheel on the interior of the structure, a welding wheel on the exterior of the structure, and conduits on both the interior and exterior of the structure for providing flood cooling.

### DESCRIPTION OF THE INVENTION

Exemplary embodiments of the present invention are now described with reference to the Figures. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

Potential applications for the flexible cladding system of the present invention cover a range of industrial sectors including oil, automotive, power generation, and consumer products. Of particular importance is the application of corrosion resistant alloy (CRA) materials to linepipes. The technology of the invention is also useful for larger scale structures (vessels) fabricated from clad flat plates. Another application involves abrasion resistant coatings. These dads may be from material compositions ranging from tool steels to refractory metals, bonded in both tubular and flat configurations. Examples include erosion critical linepipe applications, surfaces for cutting tools/implements, and automotive engine cylinder liners. Another class of applications is that requiring oxidation resistance such as combustion systems and boilers (heat exchangers).

Products, i.e., clad structures manufactured using the system of the present invention may be flats or rounds, with respect to their geometry. In most embodiments, a single cladding layer may be deposited on the inside or outside surface of the clad structure and/or the top and bottom surfaces using the device disclosed in U.S. patent application Ser. No. 12/412,685 or a suitable commercially available device such as, for example, a 400-kVA alternating current (AC) resistance seam welder with a MedWeld 3005 controller. The clad structures manufactured with this system include a substrate component, a cladding layer, and a surface activation layer. The substrate component is typically metal, such as steel. A specific example of the substrate material is 1018 hot-rolled steel, nominally 12.5-mm thick, which is representative of pipeline steel. The cladding layer is typically a refractory metal, stainless steel, tool steel, or Iconel alloy. Inconel alloys are oxidation and corrosion resistant materials well suited for service in extreme environments subjected to pressure and heat. Specific examples of the cladding layer include 1.8-mm-thick Inconel 625, 3.1-mm-thick Inconel 825, and 2-mm-thick 316 stainless steel. Surface activation may be accomplished by using specific coatings (e.g., Ni—P or Ni—B) or by using braze materials. A specific example of a braze material or alloy is 0.08-mm-thick AWS BNi-9 foil. The surface activation layer may be chemically deposited, cold sprayed, and/or plated onto either the substrate or the cladding layer. Specific advantages of this invention include: (i) texturing of surfaces is not required; (ii) the thickness of the cladding layer may be much greater than with prior art structures; (iii) system power requirements are reduced; (iv) the combinations of materials that may be used with one another is greatly expanded over prior art systems; (v) processing speed is increased over prior art systems; and (vi) the resultant surface profile is of high quality, i.e., there is low distortion. The final product has the appearance of having a solid-state weld.

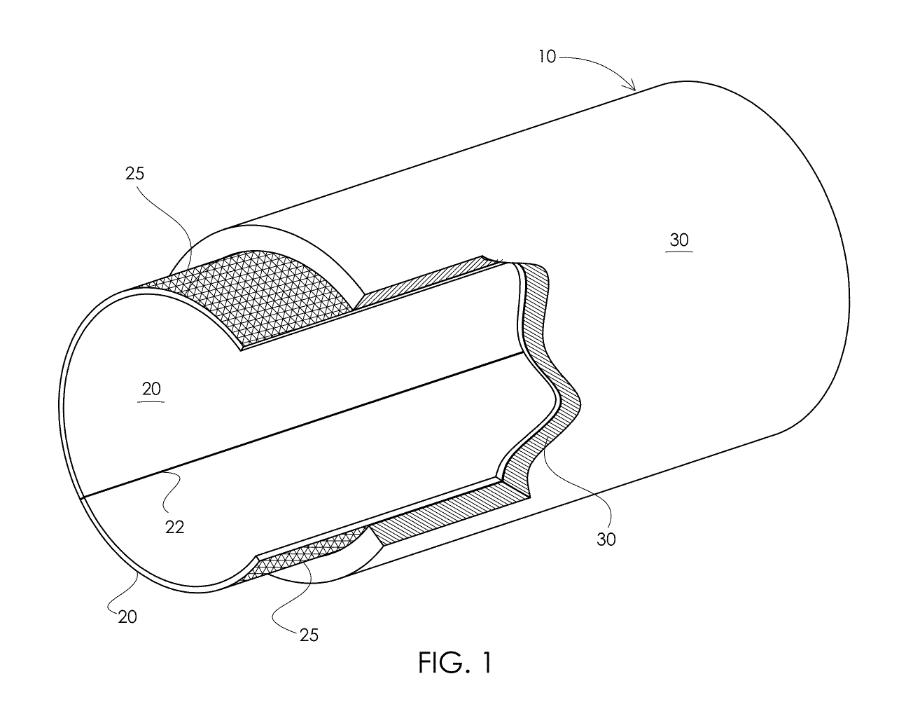

FIG. 1 provides a generalized illustration of an exemplary embodiment of a tubular clad structure 10, in accordance with this invention, that includes cladding layer 20 (having a cut line 22), surface activation layer 25, and substrate 30. A specific example of a product made using the system of this invention includes a demonstrator pipe nominally 350-mm in diameter, 300-mm long, and clad with 2-mm of IN625. The clad product was manufactured using overlapping seams nominally 6-mm to 7-mm wide. Joining was conducted circumferentially, using overlapping seams to create a nominally full bonded product. The product was sectioned, and the bond line integrity examined. The results show a highly localized bond with virtually no dilution between clad and substrate. These initial results also indicate the interdependence of weld forces, currents, and travel speeds.

The present invention is based, at least in part, on the technology disclosed in U.S. patent application Ser. No. 12/412,685 to Workman et al. entitled Method of Creating a Clad Structure Utilizing a Moving Resistance Energy Source (filed Mar. 27, 2009), which is incorporated by reference herein, in its entirety, for all purposes. Previous research largely addressed fusion-based attachment of stainless steel and nickel-based cladding to flat carbon steel plates. Processing was based on previously applied approaches to dissimilar metal thickness resistance seam welding (see, Gould, J. E., Johnson, W., and Workman, D., Development of a New Resistance Seam Cladding Process, Deep Offshore Technology Monaco 2009, PennWell Publications, Tulsa, Okla., Paper 127 (2009); and Gould, J. E., A Thermal Analysis of Resistance Seam Cladding Corrosion-Resistant Alloys to Steel Substrates, Materials Science and Technology 2009—Joining of Advanced and Specialty Materials 2009 (JASM XI), ASM, Metals Park, OH (2009), both of which are incorporated by reference herein, in their entirety, for all purposes). Additional research attempted to exploit the claims made in WO 2009/126459 A2 (the PCT equivalent to U.S. patent application Ser. No. 12/412,685), cladding a nominally 3-mm corrosion resistant alloy (CRA) to the interior of steel pipe. This research determined that the technology as described previously as applied to nickel-base alloy cladding of steel pipes was challenged by: (i) excessively slow welding speeds limiting commercial viability; (ii) distortion issues that prevented adequate bonding between the clad and substrate; and (iii) difficulty welding clad liners in the thickness range demanded by the application (3-mm).

The present invention utilizes a technology referred to as resistance seam weld cladding that uses resistance heating to create a localized bond. This bond is then driven over an extended area to create a product. Product forms include both tubular (pipe) and flat (plate) configurations. The approach offers significant cost advantages over other cladding methods in high volume production. Resistance seam weld cladding (RSeWC) is a variant of resistance seam welding (RSEW), which is a well-established technology for the joining of sheet materials (see, Welding Handbook, 9^{th} Ed., Vol. 3, Welding Processes, Part 2, American Welding Society, Miami, Fla., pp. 1-48 (2007); Recommended Practices for Resistance Welding, AWS C1.1M/C1.1:200 (R2006); and American Welding Society, Miami, Fla. (2006); Resistance Welding Manual, Fourth Ed., Resistance Welder Manufacturers Association, Miami, Fla. (2003), all of which are incorporated by reference herein, in their entirety, for all purposes). The process is typically conducted with at least one electrode wheel, which is used to allow current flow into the workpieces, as well as to apply a welding force. The resultant resistance heating of the workpieces, combined with the applied normal forces, results in the formation of a localized bond. This bond is then propagated as the wheel(s) traverse the workpieces to make continuous seams. Bonding can be the result of either melting and re-solidification of individual weld nuggets or by local deformation (see, Buer, F. Y. and Begeman, M., L., Evaluation of Resistance Seam Welds by a Shear Peel Test, Welding Journal Research Supplement, 41(3):1205-122s (1962); and Gould, J. E., Theoretical Analysis of Bonding Characteristics during Resistance Mash Seam Welding Sheet Steels, Welding Journal Research Supplement, 82(10):2635-267s (2003), both of which are incorporated by reference herein, in their entirety, for all purposes). Processes are available not only for joining steel sheet, but also a range of stainless steel and Ni-based alloys.

With regard to the RSeWC approach, clad material is prepared as an insert (similar to the approach used for mechanically clad material), and locally bonded to the substrate using a RSEW wheel. To a large degree, the process is analogous to resistance welding dissimilar materials with dissimilar thicknesses. A specific application of this process is for welding a relatively thin layer of clad material onto a much thicker substrate. Additionally, the clad layer is typically of substantially higher resistivity. Previous work has shown that proper heat balance can be accomplished by a combination of electrode design, electrode material selection, and appropriate selection of welding times or processing speeds (see, Fong, M., Tsang, A., and Ananthanarayanan, A., Development of the Law of Thermal Similarity (LOTS) for Low-Indentation Cosmetic Resistance Welds, Sheet Metal Welding Conference IX, Detroit AWS Section, Detroit, Mich., Paper 5-6 (2000); and Agashe, S. and Zhang, H., Selection of Schedules Based on Heat Balance in Resistance Spot Welding, Sheet Metal Welding Conference X, Detroit AWS Section, Detroit, Mich., Paper 1-2 (2002), both of which are incorporated by reference herein, in their entirety, for all purposes). These approaches have recently been used to develop resistance spot welding practices for stack-ups with 4:1 thickness variations (see, Gould, J. E., Peterson, W., and Cruz, J., An examination of electric servo-guns for the resistance spot welding of complex stack-ups, Welding in the World, DOI 10.1007/s40194-012-0019-x.

To address the technical challenges previously identified, further research focused on the manufacture of actual clad pipe demonstrators. The following aspects of this invention resulted from this research: (1) one side strip coating of the clad layer with micron scale active metal alloys (i.e., surface activation layer 25); (2) use of the strip as the clad material; (3) improvements in tooling to allow accurate positioning of the welding wheels facilitating accurate overlap of progressive seams; (4) proper design of welding wheels both accommodating inherent flexure in the welding machine itself, as well as providing bonded seam on the order of several millimeters; (5) the ability to clad using specifically sized preforms; (6) low cost cleaning procedures to facilitate adequate bonding between the clad and the substrate; (7) resistance heating procedures to allow reflow of the active metal layer, including (a) deliverable forces of the welding machine and (b) the desired clad metal layer thickness; and (8) flood cooling procedures to prevent surface damage to both the clad metal and the substrate. With regard to cladding CRA liners into steel pipe, five of these aspects are of particular importance.

With regard to one side strip coating with Ni—P eutectic alloy, an important aspect of this invention is the inclusion of a thin, low-cost melting point active layer affecting both the CRA and substrate. This is typically done by utilizing one side electroless nickel plating. Electroless nickel has a composition of nominally Ni-11% to 13% P. The coating may be applied by a commercial vendor or by other means. This volume of phosphorus provides a nominal 500° C. melting point suppression of the deposited nickel. The deposition process itself results in only about a 10-μm coating of the completed assembly. Single side coating allows the addition of the melting point suppressant to only the area where bonding is to occur, thereby minimizing any potential damage to the welding electrodes. Alternate coating approaches many include electroless or electrolytic methods.

With regard to use of a strip insert as the CRA layer, the CRA layer may be manufactured from strip stock nickel base CRA with the nominally 10-μm eutectic material on one side. While current methods for mechanical cladding employ pre-formed tube sections of CRA (which could also be done) there is advantage to using the clad strip stock directly. In this approach, strip material is mechanically coiled parallel to the axis of the pipe and inserted. The strip is cut to a width matching that to the substrate pipe inner diameter (ID). Once the strip is inserted, it is allowed to expand. Springback of the strip then creates fit-up between the CRA and the substrate pipe. The clad then can be welded into place using the RSeWC process. As assembled, the CRA will typically show a gap at the locations where the coiled ends meet. Once RSeWC has been completed, the remaining gap may be closed with a range of secondary joining technologies such as, for example, gas metal arc welding (GMAW), thereby completing the process of cladding.

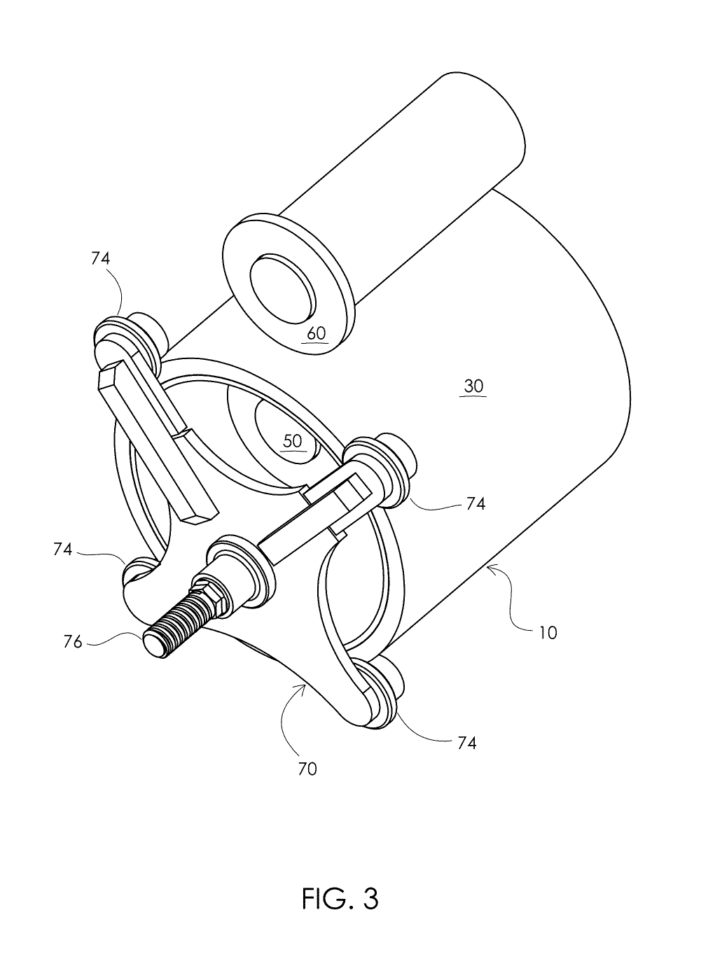

With regard to improvements to tooling for facilitating reproducible overlapping seams during RSeWC, RSeWC is typically done with normal loads ranging from several kilo-Newtons to several 10's of kilo-Newtons. Additionally, the process is known to cause small surface deformations (on the order of 100-μm), so complex forces act on the tool during processing. This combination of high normal forces and local surface deformations can cause tracking inaccuracies during processing. Initial research on flat plates used rigid tooling and demonstrated tracking appropriate for the process. This invention provides an improvement in this technology wherein the tooling used to both retain the pipe during welding, as well as to provide indexing as part of the welding process. One embodiment of this tooling uses a spring-loaded baseplate to support the pipe, rollers to provide for pipe rotation under the welding wheels, and a threaded mechanism to index the pipe as RSeWC progresses. The generalized system illustrated in FIG. 3 includes baseplate 70, support 72, rollers 74, and axle 76.

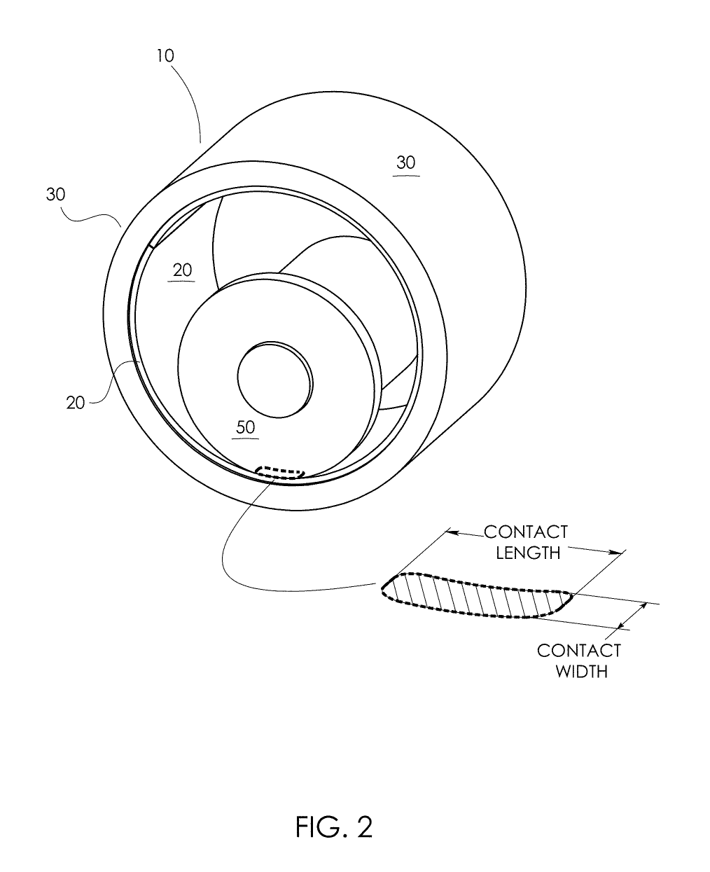

With regard to proper design of the welding wheels to accommodate flexure of the welding machine and providing adequate single pass bond width, the wheels are designed both to create a defined contact area for joining and to be sufficiently robust to any flexure of the welding machine. Wheel diameter is largely defined by the inner diameter of the clad surface for bonding. Typically, wheels are designed with a maximum diameter providing a contact length under force on the order of 4-6 times the contact width or, alternately, 6-8 times the contact width (see FIG. 2). This design also prevents or minimizes surface marking. Wheels also include a width and face radius that enable both some flexure of the welding machine and provides adequate bond width. One embodiment of this invention includes a wheel design has a width of roughly 20-mm, with a face radius of 150-mm. The use of this wheel design, combined with the processing discussed below, results in per-pass bond widths on the order of 8-mm for a 2-mm thick clad.

With regard to low cost cleaning procedures that facilitate adequate bonding between the CRA coated surface and the pipe wall itself, another important feature for creating high quality bonds between the electroless nickel plated CRA and the steel pipe is proper surface preparation. Bonding largely depends on reflow of the electroless nickel, and potential reaction with these substrates. Shot blasting with either a SiC or steel media is a suitable process and typically results in excellent bonding.

With regard to resistance heating procedures that allow reflow of the electroless nickel without significant changes to the properties of the clad and pipe materials, certain processes permit continuous bonding of the clad and substrate with minimal metallurgical changes to either component. Sample cross sections of a joint showed intimate bonding of the cladding layer and substrate with little or no evidence of retained electroless nickel. This is related to both the forces and temperatures used in the process (creating intimate fit-up), and the rapid diffusivity of the phosphorus into the parent materials. Additionally, this consolidation is done without any shielding gasses. This is a result of the high contact forces implicit in resistance processing, preventing oxygen exposure of the joint area and effectively creating a vacuum type bonding environment. Uniformity of the bond across the joint area is achieved with this process.

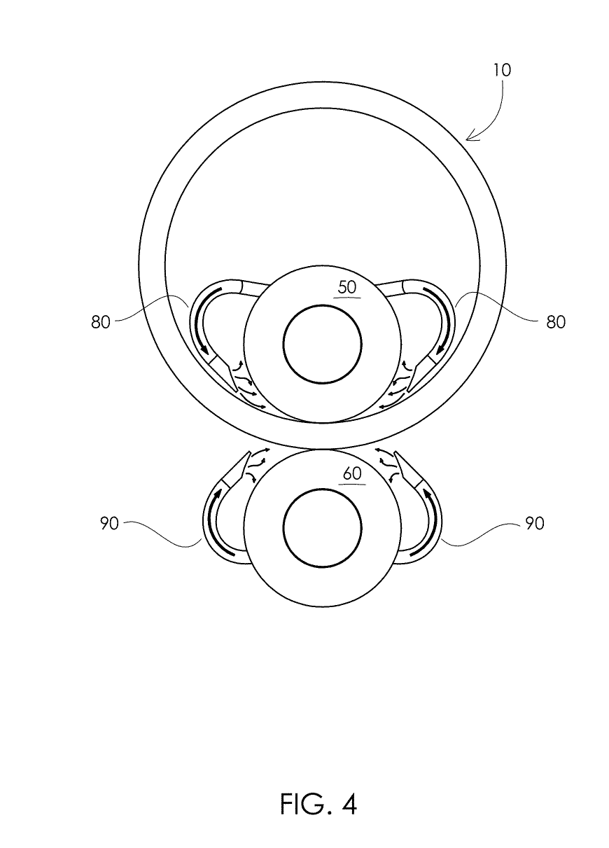

With regard to flood cooling procedures that prevent or minimize surface damage to both the CRA and the pipe itself, this aspect of the present invention is enabled by proper thermal management, thereby allowing appropriate temperatures at the joint interface without excessively heating either the substrate steel pipe or the electrode/clad contact surface. Either will lead to degradation of product performance. While heating is done resistively, cooling is done by flooding with water. Flooding is done at both the inner diameter and outer diameter surfaces of the product. Flooding is typically done with an excessive amount of water. More specifically, flooding is not done to actively control temperature profiles in the workpiece and electrodes, but rather provide a maximum cooling capability associated with the fluid medium. Without proper flood cooling, damage would likely occur to the welding wheels and clad exposed surface, as well as the metallurgy of the substrate steel pipe. Cooling of the wheels to achieve the same purpose may also be employed (see FIG. 4). The generalized system illustrated in FIG. 4 includes clad structure 10, inner welding wheel 50, outer welding wheel 60, internal cooling fluid conduits 80, and external cooling fluid conduits 90.

Achieving proper heat balance (as described above) creates conditions for bonding to occur. In embodiments where the surface activation layer is a braze alloy, a specific interlayer may be used (BNi-9) that melts at lower temperatures than either the clad or the substrate. BNi-9 is a Ni—Cr—Fe—B eutectic alloy with a distinct melting point of 1055° C. This melting point can be compared to the solidus points of the 1018 substrate (1495° C.) and the various cladding materials (1270-1370° C.). Brazing with BNi-9 is typically done in vacuum and is effective as the RSEW process results in high contact pressures (supplied by a properly designed welding wheel) over a specified area. This pressure has the effect of excluding the environment from joint area, allowing the braze alloy to flow. This is termed a “micro-environment” and combined with the temperatures provided by the resistance heating facilitates localized brazing. Joining is also enabled by the active character of the braze alloy itself. Effectively, on melting, the braze locally alloys with the substrate(s), dissociating any residual surface. This effect facilitates wetting of the braze alloy, and formation of a joint. The combination of proper thermal balance, wide temperature operating window, appropriate micro-environment, and active alloy characteristics results in effective resistance brazing.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A method for creating a clad structure, comprising:
(a) providing a substrate, wherein the substrate further includes an inner surface and an outer surface;
(b) providing a cladding material, wherein the cladding material is placed on the inner surface of the substrate, the outer surface of the substrate, or both the inner and outer surfaces of the substrate;
(c) providing a surface activation material, wherein the surface activation material is disposed between the substrate and the cladding material;
(d) providing at least one resistance welding device,
(i) wherein the at least one resistance welding device includes at least one electrode wheel that directly contacts the cladding material, and
(ii) wherein the at least one resistance welding device generates resistance heating and pressure sufficient to melt the surface activation material and form a localized bond between the substrate and the cladding layer; and
(e) traversing the at least one electrode wheel across the cladding material and substrate to propagate the localized bond between the cladding material and the substrate and create a clad structure.

2. The method of claim 1, further comprising the step of cooling the electrode wheel, cladding layer and substrate after the bond between the cladding layer and substrate has been formed.

3. The method of claim 2, wherein the cooling step includes the use of water.

4. The method of claim 1, wherein the geometry of the substrate is curved or wherein the geometry of the substrate is flat.

5. The method of claim 1, wherein the substrate is hot-rolled pipeline steel.

6. The method of claim 1, wherein the cladding material is stainless steel, tool steel, Iconel alloy, or a refractory metal.

7. The method of claim 1, wherein the surface activation material is a Ni—Cr—Fe—B eutectic alloy.

8. The method of claim 1, wherein the surface activation material is a nickel phosphorus alloy or a nickel boron alloy.

9. The method of claim 1, wherein the surface activation layer is chemically deposited, cold sprayed, or plated onto either the substrate or the cladding layer prior to creation of the clad structure.

10. The method of claim 1, wherein the resistance welding device is a 400-kVA alternating current resistance seam welder.

11. A method for creating a clad structure, comprising:
(a) providing a curved substrate, wherein the curved substrate further includes an inner surface and an outer surface;
(b) providing a cladding material, wherein the cladding material is placed on the inner surface of the curved substrate, the outer surface of the curved substrate, or both the inner and outer surfaces of the curved substrate;
(c) providing a surface activation material, wherein the surface activation material is disposed between the curved substrate and the cladding material;
(d) providing at least one resistance welding device,
(i) wherein the at least one resistance welding device includes at least one electrode wheel that directly contacts the cladding material, and
(ii) wherein the at least one resistance welding device generates resistance heating and pressure sufficient to melt the surface activation material and form a localized bond between the curved substrate and the cladding layer;
(e) traversing the at least one electrode wheel across the cladding material and curved substrate to propagate the localized bond between the cladding material and the curved substrate and create a clad structure; and
(f) cooling the electrode wheel, cladding layer and curved substrate after the bond between the cladding layer and curved substrate has been formed.

12. The method of claim 11, wherein the substrate is hot-rolled pipeline steel, and wherein the cladding material is stainless steel, tool steel, Iconel alloy, or a refractory metal.

13. The method of claim 11, wherein the surface activation material is a Ni—Cr—Fe—B eutectic alloy, a nickel phosphorus alloy, or a nickel boron alloy.

14. The method of claim 11, wherein the surface activation layer is chemically deposited, cold sprayed, or plated onto either the substrate or the cladding layer prior to creation of the clad structure.

15. The method of claim 11, wherein the resistance welding device is a 400-kVA alternating current resistance seam welder.

16. A method for creating a clad structure, comprising:
(a) providing a cylindrical substrate, wherein the cylindrical substrate further includes an inner surface and an outer surface;
(b) providing a cladding material, wherein the cladding material is placed on the inner surface of the cylindrical substrate, the outer surface of the cylindrical substrate, or both the inner and outer surfaces of the cylindrical substrate;
(c) providing a surface activation material, wherein the surface activation material is disposed between the cylindrical substrate and the cladding material;
(d) providing at least one resistance welding device,
(i) wherein the at least one resistance welding device includes at least one electrode wheel that directly contacts the cladding material, and
(ii) wherein the at least one resistance welding device generates resistance heating and pressure sufficient to melt the surface activation material and form a localized bond between the cylindrical substrate and the cladding layer;
(e) traversing the at least one electrode wheel across the cladding material and cylindrical substrate to propagate the localized bond between the cladding material and the cylindrical substrate and create a clad structure; and
(f) cooling the electrode wheel, cladding layer and cylindrical substrate with water after the bond between the cladding layer and cylindrical substrate has been formed.

17. The method of claim 16, wherein the substrate is hot-rolled pipeline steel, and wherein the cladding material is stainless steel, tool steel, Iconel alloy, or a refractory metal.

18. The method of claim 16, wherein the surface activation material is a Ni—Cr—Fe—B eutectic alloy, a nickel phosphorus alloy, or a nickel boron alloy.

19. The method of claim 16, wherein the surface activation layer is chemically deposited, cold sprayed, or plated onto either the substrate or the cladding layer prior to creation of the clad structure.

20. The method of claim 16, wherein the resistance welding device is a 400-kVA alternating current resistance seam welder.
